(19) United States
(12) Patent Application Publication
(10) Pub. No.: US 2026/0252614 A1
(43) Pub. Date: Aug. 27, 2026

(54) DETECTION OF MISSING AND HALLUCINATED CONTEXT IN GENERATED SUMMARY

(71) Applicant: International Business Machines Corporation, Armonk, NY (US)

(72) Inventors: Abhay Choudhary, MULHUDDART (IE); Akash Bhargava, MULHUDDART (IE); Adrian Mahjour, Markham (CA); Shubham Sharma, Dublin (IE)

(21) Appl. No.: 19/065,598

(22) Filed: Feb. 27, 2025

(51) Int. Cl. G06F 16/34; G06F 16/334

(52) U.S. Cl. CPC G06F 16/345; G06F 16/334

(57) ABSTRACT

An example operation includes one or more of executing a ML model on an input text to generate an output text that comprises a summary of the input text, wherein the input text includes a first group of sentences and the output text comprises a second group of sentences, generating different possible combinations of sentences from the first group of sentences and embedding the different possible combinations of sentences to generate a plurality of embeddings in vector space, embedding a sentence from the output text in the vector space to generate a target embedding, identifying a hallucination within the output text based on a distance between the target embedding and the plurality of embeddings in the vector space, and generating a feedback record that includes the input text, the output text, and the hallucination within the output text.

### BACKGROUND

Generative machine learning (ML), also known as generative artificial intelligence (AI), is a type of machine learning that creates new data that is similar to the data that was used to train the model. Generative models are advanced neural networks that learn the patterns and distributions in training data, and then use that knowledge to generate new content. Meanwhile, a hallucination occurs when a generative model produces inaccurate or fabricated results. The problem of hallucinations is a significant issue in ML/AI, because it limits the model's ability to interpret context and facts properly.

### SUMMARY

One example embodiment provides a method that may include one or more of executing a machine learning (ML) model on an input text to generate an output text that comprises a summary of the input text, wherein the input text includes a first group of sentences and the output text comprises a second group of sentences, generating different possible combinations of sentences from the first group of sentences and embedding the different possible combinations of sentences to generate a plurality of embeddings in vector space, embedding a sentence from the output text in the vector space to generate a target embedding, identifying a hallucination within the output text based on a distance between the target embedding and the plurality of embeddings in the vector space, and generating a feedback record that includes the input text, the output text, and the hallucination within the output text.

Another example embodiment provides a computer system that may include a processor set, a set of one or more computer-readable storage media, and program instructions, collectively stored in the set of one or more storage media, that cause the processor set to perform computer operations that may include one or more of executing a ML model on an input text to generate an output text that comprises a summary of the input text, wherein the input text includes a first group of sentences and the output text comprises a second group of sentences, generating different possible combinations of sentences from the first group of sentences and embedding the different possible combinations of sentences to generate a plurality of embeddings in vector space, embedding a sentence from the output text in the vector space to generate a target embedding, identifying a hallucination within the output text based on a distance between the target embedding and the plurality of embeddings in the vector space, and generating a feedback record that includes the input text, the output text, and the hallucination within the output text.

A further example embodiment provides a computer program product that may include a set of one or more computer-readable storage media, and program instructions, collectively stored in the set of one or more computer-readable storage media, for causing a processor set to perform computer operations that may include one of more of executing a ML model on an input text to generate an output text that comprises a summary of the input text, wherein the input text includes a first group of sentences and the output text comprises a second group of sentences, generating different possible combinations of sentences from the first group of sentences and embedding the different possible combinations of sentences to generate a plurality of embeddings in vector space, embedding a sentence from the output text in the vector space to generate a target embedding, identifying a hallucination within the output text based on a distance between the target embedding and the plurality of embeddings in the vector space, and generating a feedback record that includes the input text, the output text, and the hallucination within the output text.

### BRIEF DESCRIPTION OF THE DRAWINGS

FIG. 1 is a diagram illustrating a computing environment according to an embodiment of the instant solution.

FIG. 2A is a diagram illustrating a process of detecting different types of hallucinations in the context of a summary generated by an ML model from input text according to an embodiment of the instant solution.

FIG. 2B is a diagram illustrating examples of various types of summaries with different types of hallucinations according to embodiments of the instant solution.

FIG. 2C is a diagram illustrating a multi-stage detection process for contextual hallucinations and missing context according to embodiments of the instant solution.

FIG. 2D is a diagram illustrating a process of retraining the ML model based on the hallucinations according to an embodiment of the instant solution.

FIG. 3A is a diagram illustrating a process of generating an embedding index according to an embodiment of the instant solution.

FIG. 3B is a diagram illustrating a process of detecting a contextual hallucination based on the embedding index according to an embodiment of the instant solution.

FIG. 3C is a diagram illustrating a process of generating a similarity matrix according to an embodiment of the instant solution.

FIG. 3D is a diagram illustrating a process of detecting missing context from a summary according to an embodiment of the instant solution.

FIG. 4A is a flow diagram illustrating a method according to examples and features of the instant solution.

FIG. 4B is a flow diagram illustrating a method according to additional examples and features of the instant solution.

FIG. 5A is a system diagram illustrating integration of an AI model into any decision point according to the examples and features of the instant solution.

FIG. 5B is a diagram illustrating a process for developing an AI model that supports AI-assisted computer decision points according to the examples and features of the instant solution.

FIG. 5C is a diagram illustrating a process for utilizing an AI model that supports AI-assisted computer decision points according to examples and features of the instant solution.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to various embodiments, a machine learning model such as a generative model may receive, as input, text content such as an article of content, a message, multiple messages, text from a book, text from a magazine, text from a news story, and the like, and generate an output that includes a “summary” of the text content. The summary may include significantly less content that is also in descriptive form, and which summarizes the text content input to the ML model. As noted above, there is always the chance of hallucinations that can occur when generating such as summary of content. The hallucinations may differ between different ML models making some ML models worse than others for certain tasks.

However, validating a text summary against the actual input data is not an easy task. This becomes even more difficult if the summary does not summarize content from the input text. In other words, the content from the input text is missing from the summary. Related solutions such as non-contextual models such as Rough, Blue, etc. are not designed to tackle this problem.

The example embodiments are directed to a system that can verify a summarization generated by an ML model and generate a score/accuracy of the ML based on the verification. The system may detect both contextual hallucinations and missing context from the summary. A contextual hallucination occurs when the output content contradicts itself. For example, a contextual hallucination may occur when the system outputs information without any specific request for that information (e.g., the model suddenly provides a description of steak when the question was about fried chicken and mashed potatoes, etc.) Meanwhile, missing context is content from the input text that is not described and is not summarized in the summary.

Transformer models are good at detecting both contextual hallucinations and missing context as both are context related problems. In this solution, a transformer model (e.g., a cross-encoder model, etc.) which is a type of transformer model, is used to detect both contextual hallucinations in the summary, and content in the input data that is missing from the summary.

The system described herein can address the above-mentioned deficiencies in hallucination detection in machine learning and extract context that deviates/hallucinates in the output summary generated by the model in comparison to the input text. The system can also identify context from the input text that the summary does not contain (i.e., that is missing). Related art hallucination detections systems have no way of finding out what context is hallucinating in the output summary generated by the LLM nor context that is missing. With this solution, both of these problems are addressed thereby improving the LLM summary quality by finding the context of the hallucinations and by pointing out what context is missing in the summary.

Some of the benefits of the example embodiments include a hallucination detection system that can identify contextual hallucinations rather as well as missing context from a generative summary. By detecting contextual-based hallucinations and missing context, the system described herein can improve the hallucination detection process that exists. It can also improve the models themselves by creating a bigger feedback record with more information (contextual-based hallucinations and missing context) that can be used to retrain the model. The result is a more accurate ML model. Furthermore, the speed at which the process can be performed is significantly faster in comparison to related hallucination detection systems because the contextual hallucinations and the missing context can be detected/processed in parallel through a multi-stage process performed by the system described herein.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

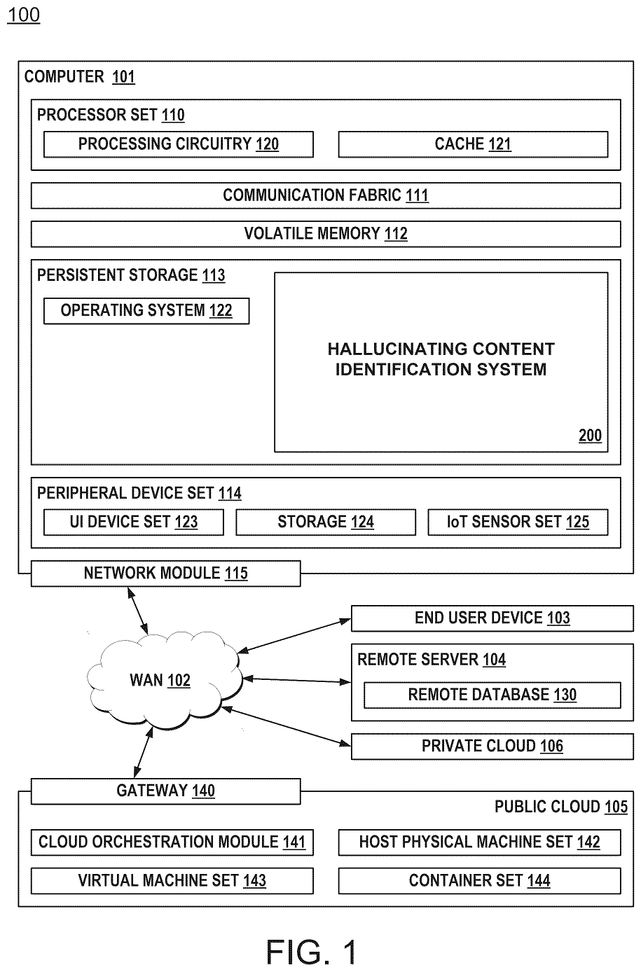

FIG. 1 illustrates a computing environment 100 that contains an example of an environment for the execution of at least some of the computer code involved in performing the inventive methods, such as hallucinating content identification system 200 which is configured to detect hallucinations that are generated by a ML model, AI model, or the like. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The example embodiments are directed to a system, such as a software application, for identifying hallucinations that have been generated by a machine learning (ML) model. The system is capable of detecting both contextual hallucinations and missing context using two separate mechanisms that can be executed in parallel by the system. In some embodiments, the system may be coupled to an input layer and an output layer of the ML model enabling the system to receive the input text provided to the ML model and the summary of the input text generated by the ML model from the input text.

For example, the system may import the actual input data and that summarized data produced by the ML model. The system may determine a similarity score between two texts using an additional machine learning model or models which may compare the vectorized input data to the vectorized summary to identify a similarity between each part of the input text and the summary. The contextual-based analysis may be referred to as a first stage of the hallucination detection process.

In the second stage, the system may identify missing data from the input text that the summary does not describe. For the second stage, the system may structure the input text into a first group of sentences and structure the summary into a second group of sentences. The system may execute one or more additional machine learning models on the input text and the summary to determine how similar each sentence in the input text is to each sentence in the summary. If a sentence from the input text is not similar enough to any of the sentences in the summary, the sentence from the input text is detected as “missing” from the summary.

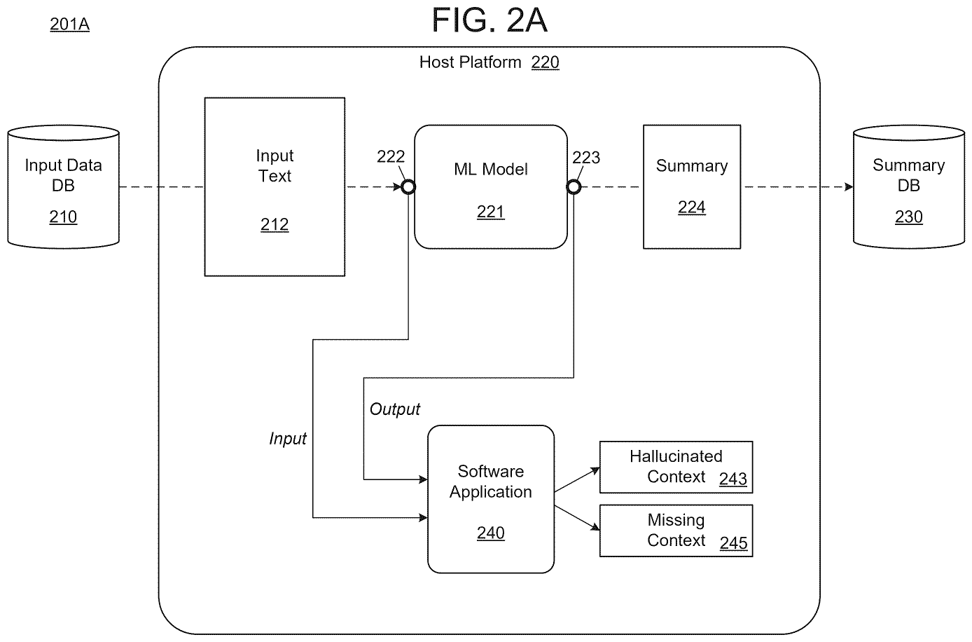

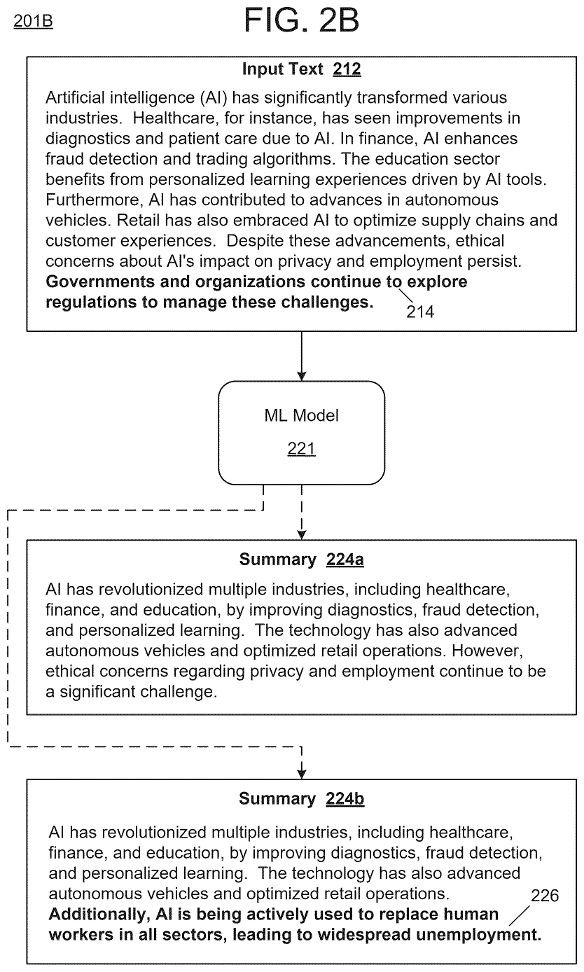

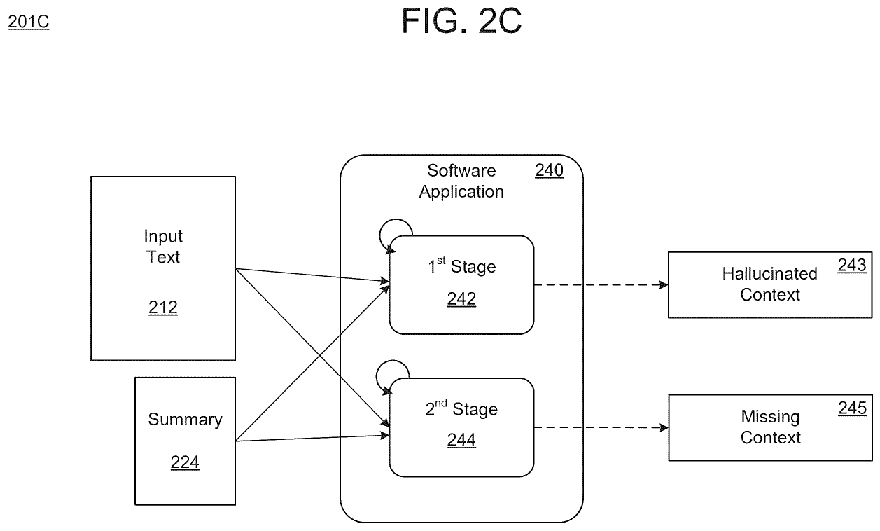

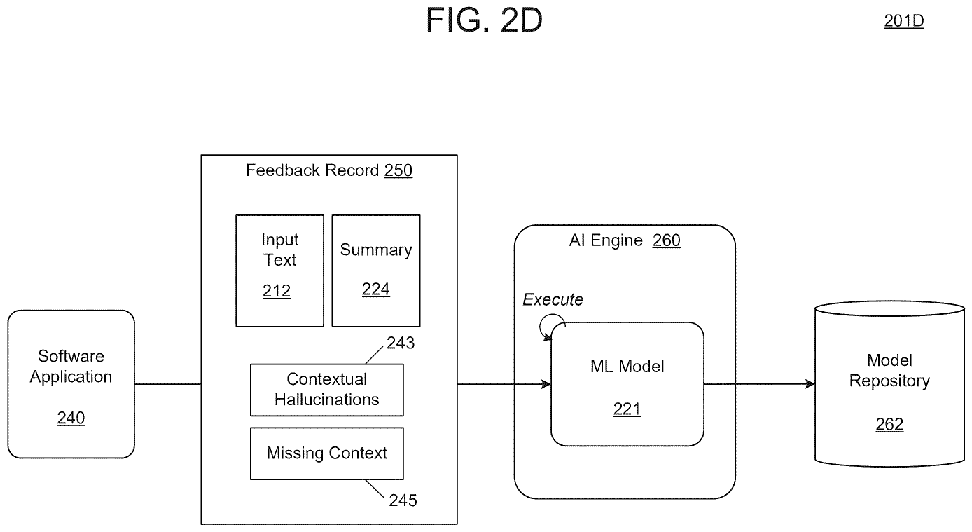

FIG. 2A illustrates a process 201A of detecting different types of hallucinations in the context of a summary 224 generated by an ML model 221 from input text 212 according to an embodiment of the instant solution. Referring to FIG. 2A, a host platform 220 may host the ML model 221 and a software application 240 which is made available to end users over the Internet, a private network, an on-premises system, and the like. The software application 240 may include the ML model 221 or may be communicably coupled to the ML model 221. For example, the ML model 221 may be a large language model (LLM), or other type of generative model which can receive the input text 212 (e.g., article, page of content, book, manual, code segment, etc.) from a database 210 and generate a summary 224 of the input text 212 that summarizes the description of content within the input text 212 usually in significantly less words/sentences. The output from the ML model 221 is the summary 224. The summary 224 may be recorded in a summary database 230.

According to various embodiments, a software application 240 may detect contextual hallucinations and missing content within the summary 224, which is the result of the generative content generated by the ML model 221. Contextual hallucinations include context that is added to the summary that is not found in the input text 212. Meanwhile, missing content refers to content that is described in the input text 212 which is not summarized within the summary 224. The software application 240 can be attached/coupled to an input 222 of the ML model 221 and an output 223 of the ML model 221 enabling the software application 240 to capture both the input text 212 that goes into the input 222 of the ML model 221 and the summary 224 that is output by the output 223 of the ML model 221. For example, the input 222 may refer to an input layer of neurons in the LLM, while the output 223 may refer to an output layer of neurons in the LLM, however, embodiments are not limited thereto.

The software application 240 may ingest the input text 212 and the summary 224 and execute a multi-stage process as further described with respect to FIG. 2C. A first stage of the multi-stage process executed by the software application 240 may be used to detect contextual-based hallucinations while a second stage of the multi-stage process may be used to detect missing content/context from the summary 224. In some embodiments, the first stage and the second stage of the multi-stage process may be executed simultaneously. For example, execution times of the first stage and the second stage may share clock cycles of a multi-core processor where a first core executes the first stage and a second core executes the second stage at the same time (shared clock cycles).

In the example of FIG. 2A, the software application 240 identifies contextual hallucinations 243 and missing context 245 from the summary 224. The software application 240 may also generate an accuracy value (not shown) that represents whether the summary 224 generated by the ML model 221 is of high enough quality that it is above a threshold and is therefore considered a success, or if the quality of the summary 224 is below a threshold which is considered a failure.

FIG. 2B illustrates a view 201B of examples of various types of hallucinations according to embodiments of the instant solution. Referring to FIG. 2B, a sample of the input text 212 is shown which includes a description of artificial intelligence and its advancements and impacts in different areas. As an example, the ML model 221 may receive the input text 212 and generate different types of summaries as outputs. For example, the ML model 221 may generate a summary 224a which does not include a hallucination, however it is missing a sentence of context 214 from the input text 212. As another example, the ML model 221 may generate a summary 224b which includes a contextual hallucination 226. In addition, the summary 224b is also missing the sentence of context 214 from the input text 212.

For example, the summary 224a includes a group of sentences that can each be traced back to sentences from the input text 212, except for the sentence of context 214 which is highlighted/bolded in the input text 212. Therefore, the summary 224a is detected as being an inaccurate summary. Meanwhile, the summary 224b contains additional content that is not found in the input text 21 (i.e., the contextual hallucination 226) which is highlighted with bolded lettering in the summary 224b and which cannot be identified from the input text 212. The additional content from the contextual hallucination 226 is therefore considered a contextual hallucination because the ML model 221 is generating content that includes additional contextual data that is not found in the input, but which is not necessarily incorrect.

FIG. 2C illustrates a multi-stage detection process 201C for contextual hallucinations and missing context according to embodiments of the instant solution. For example, the multi-stage detection process 201C may be used to detect both contextual-based hallucinations (e.g., summary 224b, etc.) and missing content (e.g., summary 224a and summary 224b, etc.) The two stages may be executed in parallel, at the same time, using multiple processing cores, multiple pipelines, etc. As another example, the two stages may be executed sequentially.

Referring to FIG. 2C, the software application 240 may ingest the input text 212 and the summary 224 and input both the input text 212 and the summary 224 to a first stage 242 of the hallucination determination process and a second stage 244 of the hallucination determination process. During the first stage 242, the software application may execute a process to identify contextual hallucinations 243. Meanwhile, during the second stage 244, the software application 240 may execute a process to identify missing context 245. The contextual hallucinations 243 and the missing context 245 may be used to determine an accuracy of the ML model 221.

FIG. 2D illustrates a process 201D of retraining the ML model based on the hallucinations according to an embodiment of the instant solution. Referring to FIG. 2D, the host platform 220 may also host an AI engine 260 that is capable of retraining the ML model 221. For example, the AI engine 260 may execute a script which causes the AI engine 260 to retrieve training data and input the training data to the ML model 221 while the model is executing. Referring to FIG. 2D, the software application 240 may generate a feedback record 250 that includes the input text 212, the summary 224 which is generated by the ML model 221, the contextual hallucinations 243 and the missing context 245 that are detected by the system.

According to various embodiments, the software application 240 may transfer the feedback record 250 to the AI engine 260 which causes the ML model 221 to execute on the feedback record 250 and learn from the content included in the feedback record 250. For example, the execution of the ML model 221 on the feedback record 250 may cause parameter values, weights, and the like, within the ML model 221 to be changed. The retrained model may be more accurate than it previously was as a result of the retraining process. Thus, the ML model 221 can continue to evolve and learn as it is being used. The retrained model may be stored in a model repository 262 and used during subsequent executions for generating summaries from input text.

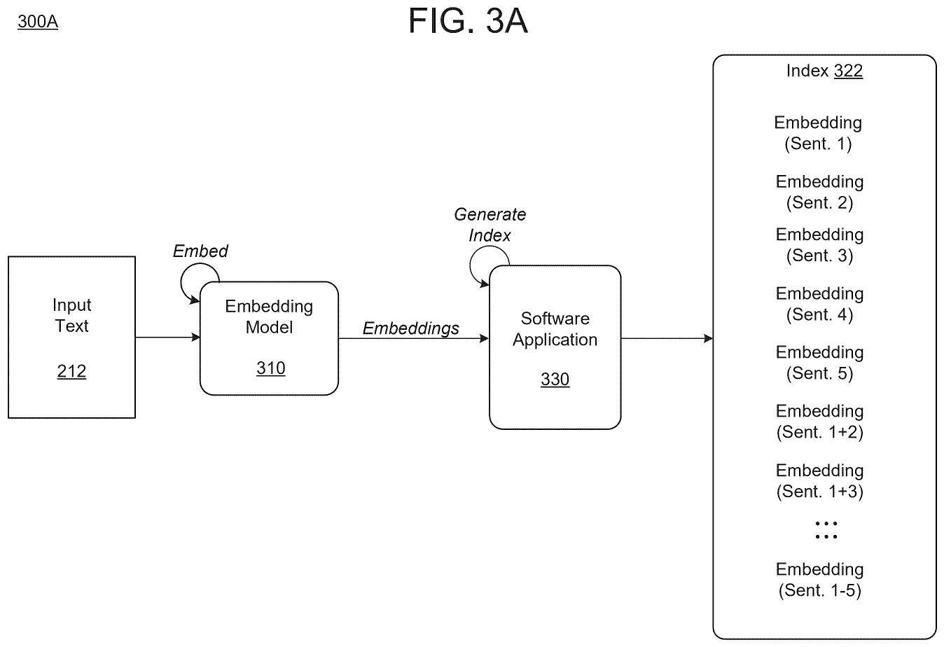

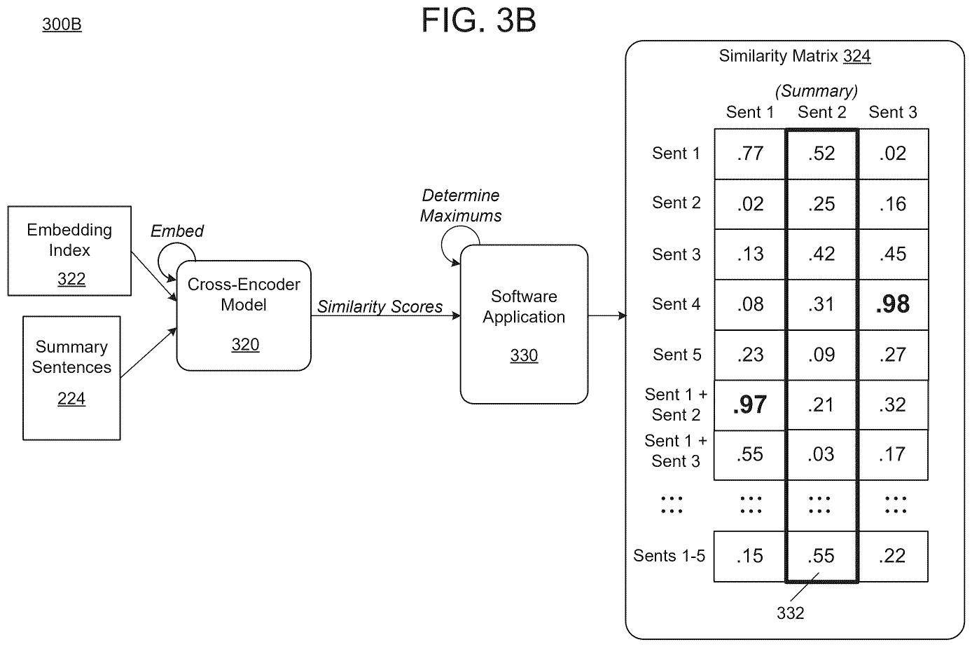

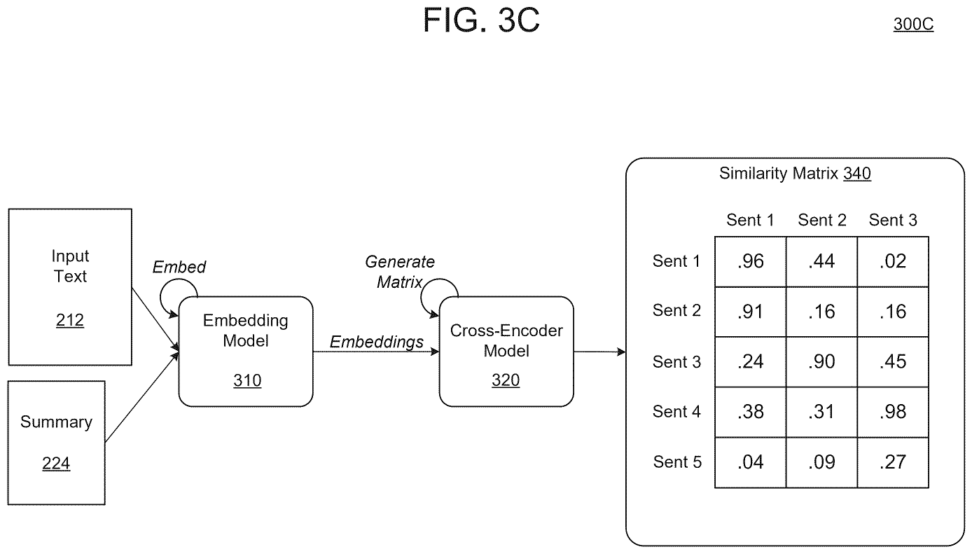

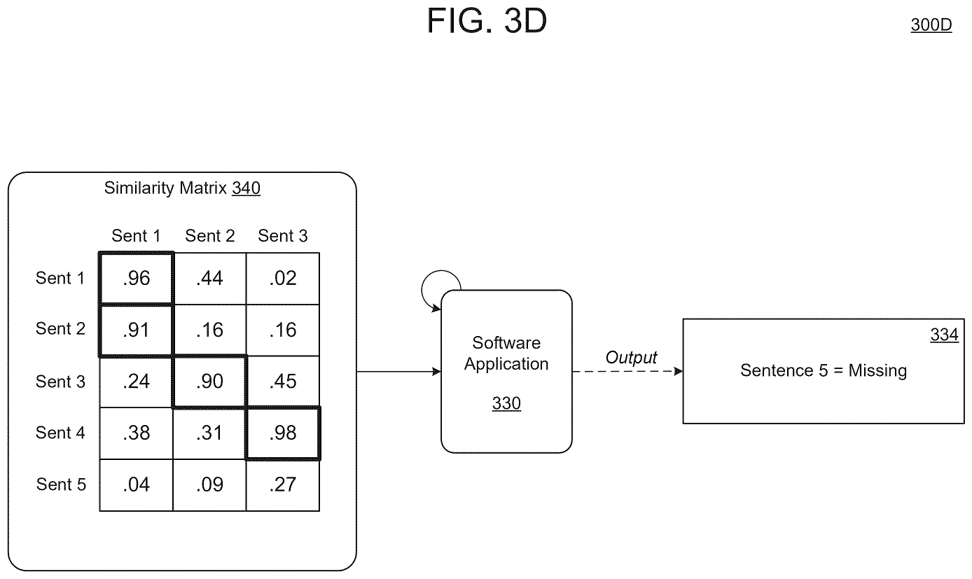

FIG. 3A illustrates a process 300A of generating an embedding index according to an embodiment of the instant solution, and FIG. 3B illustrates a process 300B of detecting a contextual hallucination based on the embedding index according to an embodiment of the instant solution. The processes 300A and 300B may be performed by a software application 330. For example, the processes 300A and 300B may correspond to the first stage 242 of the process performed by the software application 240 that is shown and described with respect to FIG. 2C. Referring to FIGS. 3A and 3B, the software application 330 may host or otherwise be communicably coupled to a contextual embedding model 310 such as a machine learning model that is configured to embed text content within a multi-dimensional embedding space, such as vector space, and perform a similarity analysis by determining a distance between two pieces of content within the multi-dimensional embedding space.

To detect contextual hallucinations, the software application 330 may take the input text 212 and convert it into all possible sentence combinations. The combinations include each individual sentence by itself and each individual sentence combined with one or more other sentences until all possible combinations are checked. For example, if the input text includes three (3) sentences, there will be eight (8) possible sentence combinations including each of the three sentences by themselves (3 combinations), and each sentence combined with one of the others (4 combinations), and all of the sentences combined together (1 combination).

The contextual embedding model 310 may be a machine learning model that generates numerical representations of words, sentences, or paragraphs, where the representation of each word is dynamically adjusted based on its surrounding context within the text, capturing nuanced meanings and relationships between words that go beyond their standalone definition. The contextual embedding model 310 allows a word to have different meanings depending on the sentence it appears in, providing a more accurate semantic understanding of language.

Here, the contextual embedding model 310 receives the input text 212 generated by the ML model 221, and converts the text content into all possible sentence combinations into multi-dimensional embeddings. The output of the contextual embedding model 310 (e.g., the embeddings of all possible combinations of the sentences from the input text 212) are then added to an index 322. As an example, the index 322 may be a FACEBOOK® AI Similarity Search (FAISS) index that stores embeddings, vectors, and the like. A FAISS index is designed for efficient similarity searching and clustering of dense vectors. For example, using algorithms like k-means clustering and product quantization, the FAISS index is able to organize and retrieve embeddings efficiently ensuring similarity searches are quick and accurate. Thus, the software application 330 may convert the input text 212 into all possible combinations of sentences for the input text. Then the software application 330 can create embeddings for all possible combinations of sentences and store the embeddings in the index 322.

Although not shown in FIG. 3A, in some embodiments, the input text 212 may be structured or unstructured text. If the input text 212 is unstructured text, an additional ML model (not shown) may be executed on the input text 212 to create sentences from the unstructured text. Likewise, if the summary 224 is unstructured text, the additional ML model (not shown) may be executed on the summary 224 to create sentences from the unstructured text.

Referring now to FIG. 3B, a software application 330 may determine if contextual hallucinations exist in the summary 224 based on similarities between the embeddings in the index 322 and the sentences/embeddings in the summary 224. For example, the software application 330 may calculate a plurality of similarity scores between a summary sentence embedding and each of the plurality of sentence embeddings in the index 322. This results in a plurality of respective similarity scores being generated for the plurality of sentence embeddings, respectively, for each summary sentence by the software application 330. The software application 330 may record the similarity scores in a similarity matrix 324 stored in a database. The software application 330 identifies the maximum value from the top N summary scores for a summary sentence from the similarity matrix 324 and compares the maximum summary score from among the top N summary scores for the summary sentence to a threshold. The similarity score represents the contextual score for the summary. If the maximum similarity value is less than a predefined threshold, then this particular sentence can be deemed as hallucinating. The system may use a predefined threshold value (e.g., 0.5, 0.6, 0.7, etc.) and compare the similarity scores to the predefined threshold value.

If the maximum similarity score for a summary sentence is below the predefined threshold value, the corresponding sentence from the summary 224 is considered to be a contextual hallucination. Meanwhile, if the maximum similarity score for a summary sentence is above the predefined threshold value, the corresponding sentence is considered to be a correct summary of the sentence (or combination of sentences) from the input text 212. In the example of FIG. 3B, the software application 330 detects that the second sentence from the summary is a contextual hallucination based on a maximum similarity score 332 in the similarity matrix 324 for the second sentence from the summary, and outputs an indicator of the contextual hallucination (not shown). Here, the maximum similarity score 332 is below a predetermined threshold required for a match and is therefore considered a contextual hallucination.

In the examples of FIGS. 3A and 3B, the software application 330 may create normalized embeddings for both input sentence combinations and summary sentences using a transformer model (trained or pre-trained) such as a cross-encoder model 320 or the like that can understand the context of text. The system may create the index 322 based on embeddings for all input sentence combinations. An example of the index 322 is a Facebook AI Similarity Search (FAISS) index. The software application 330 may take one summary sentence at a time and retrieve the top N closest input sentence combinations by searching in the FAISS index. Here, N may be a predefined value such as 5, 10, 15, etc. Using a cross-encoder model(s) 320, the software application 330 generates similarity scores between the summary sentence and the top N input sentence combinations, as an example. The maximum value of these N scores will be the maximum similarity score for the summary sentence. The software application 330 may repeat this same process for all summary sentences. The software application 330 may then use the maximum similarity scores to identify if contextual hallucinations exist.

FIG. 3C illustrates a process 300C of generating a similarity matrix according to an embodiment of the instant solution, and FIG. 3D illustrates a process 300D of detecting missing context from a summary according to an embodiment of the instant solution. For example, the processes 300C and 300D may correspond to the second stage 244 of the process performed by the software application 240 that is shown and described with respect to FIG. 2C. The software application described herein may detect when contextual data (e.g., sentences) from the input text 212 are missing (not described or summarized) by the summary 224 generated by the ML model 221. Missing content, although not necessarily a hallucination, reduces the accuracy of the summary that is generated. The example embodiments may identify the missing content (and the contextual hallucinations) and use both to retrain the ML model 221 as shown and described in the example of FIG. 2D.

Referring now to FIGS. 3C and 3D, the contextual embedding model 310 receives the input text 212 and the summary 224 generated by the ML model 221, and converts the text content into n—dimensional embeddings. The output of the contextual embedding model 310 (e.g., the embeddings of the sentences from the input text 212 and the summary 224) are input to the cross-encoder model 320. In this example, the cross-encoder model 320 may compare each sentence in the input text 212 to each sentence in the summary 224 to determine a similarity score for each respective sentence in the input text 212 with respect to each respective sentence in the summary 224. The software application 330 may then build a similarity matrix 340 which includes the similarity scores. The purpose of building the similarity matrix 340 is to determine if the context of all of the input sentences in the input text 212 are found in the summary 224.

In the example of FIGS. 3C and 3D, the cross-encoder model 320 is used to generate many-to-many similarity scores between input and summary sentences. The similarity matrix 340 is created where columns represent input sentences and rows represent summary sentences. The similarity scores represent how much of the input sentence context is present in a summary sentence.

Referring now to FIG. 3D, the software application 330 may take the max of each row and get the max score for each input sentence. When the max score for a row is less than a predefined threshold value (e.g., 0.6, 0.7, 0.8, etc.) the sentence from the input text 212 can be identified as having missing context/representation in the summary 224, else not. The score is published as well. Here, the software application 330 identifies that a fifth sentence from the input text 212 is missing from the summary 224, and outputs an indicator 334 of the missing sentence.

The indicator output from the process shown in FIG. 3B and the indicator output from the process shown in FIG. 3D, may be fed to the AI engine (or another system) that then retrains the ML model 221 based on the hallucinating content and the missing content.

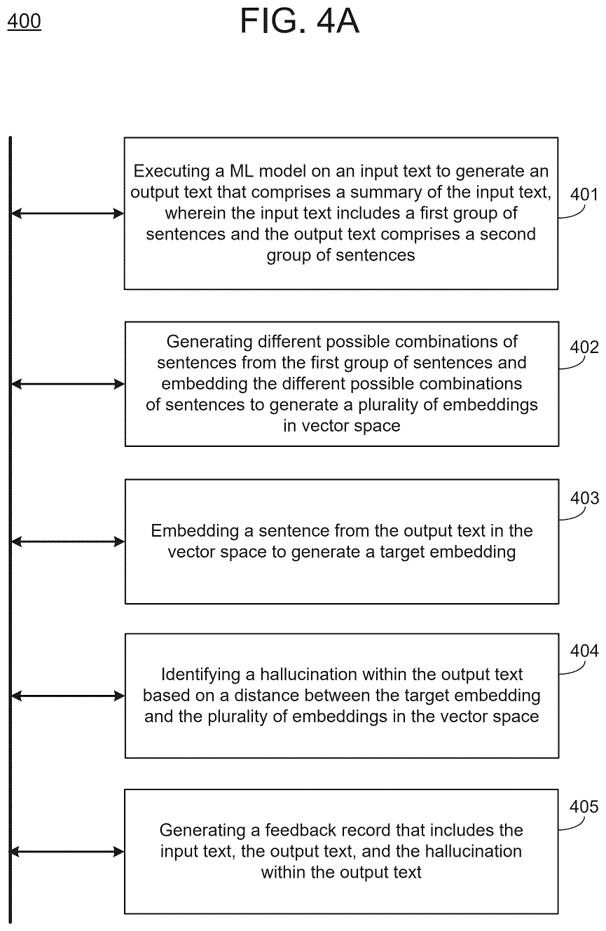

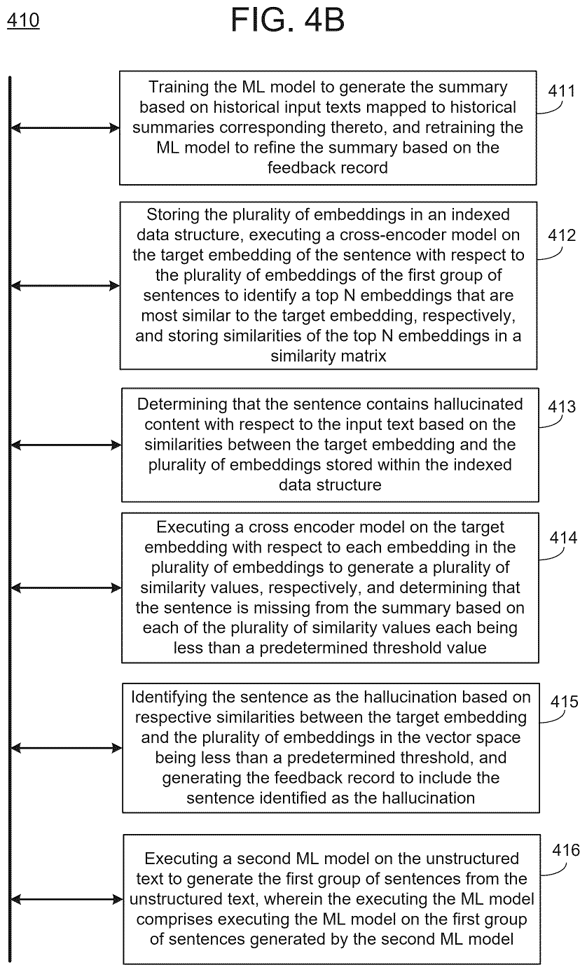

FIG. 4A illustrates a flow diagram of a method 400, according to example embodiments. Referring to FIG. 4A, in 401, the method may include executing a ML model on an input text to generate an output text that comprises a summary of the input text, wherein the input text includes a first group of sentences and the output text comprises a second group of sentences. In 402, the method may include generating different possible combinations of sentences from the first group of sentences and embedding the different possible combinations of sentences to generate a plurality of embeddings in vector space. In 403, the method may include embedding a sentence from the output text in the vector space to generate a target embedding. In 404, the method may include identifying a hallucination within the output text based on a distance between the target embedding and the plurality of embeddings in the vector space. In 405, the method may include generating a feedback record that includes the input text, the output text, and the hallucination within the output text.

FIG. 4B illustrates a flow diagram of a method 410, according to example embodiments. Referring to FIG. 4B, in 411, the method may include training the ML model to generate the summary based on historical input texts mapped to historical summaries corresponding thereto, and retraining the ML model to refine the summary based on the feedback record. In 412, the method may include storing the plurality of embeddings in an indexed data structure, executing a cross-encoder model on the target embedding of the sentence with respect to the plurality of embeddings of the first group of sentences to identify a top N embeddings that are most similar to the target embedding, respectively, and storing similarities of the top N embeddings in a similarity matrix.

In 413, the method may include determining that the sentence contains hallucinated content with respect to the input text based on the similarities between the target embedding and the plurality of embeddings stored within the indexed data structure. In 414, the method may include executing a cross encoder model on the target embedding with respect to each embedding in the plurality of embeddings to generate a plurality of similarity values, respectively, and determining that the sentence is missing from the summary based on each of the plurality of similarity values each being less than a predetermined threshold value.

In 415, the method may include identifying the sentence as the hallucination based on respective similarities between the target embedding and the plurality of embeddings in the vector space being less than a predetermined threshold, and generating the feedback record to include the sentence identified as the hallucination. In 416, the input text includes unstructured text, and the method may include executing a second ML model on the unstructured text to generate the first group of sentences from the unstructured text, and the executing the ML model includes executing the ML model on the first group of sentences generated by the second ML model.

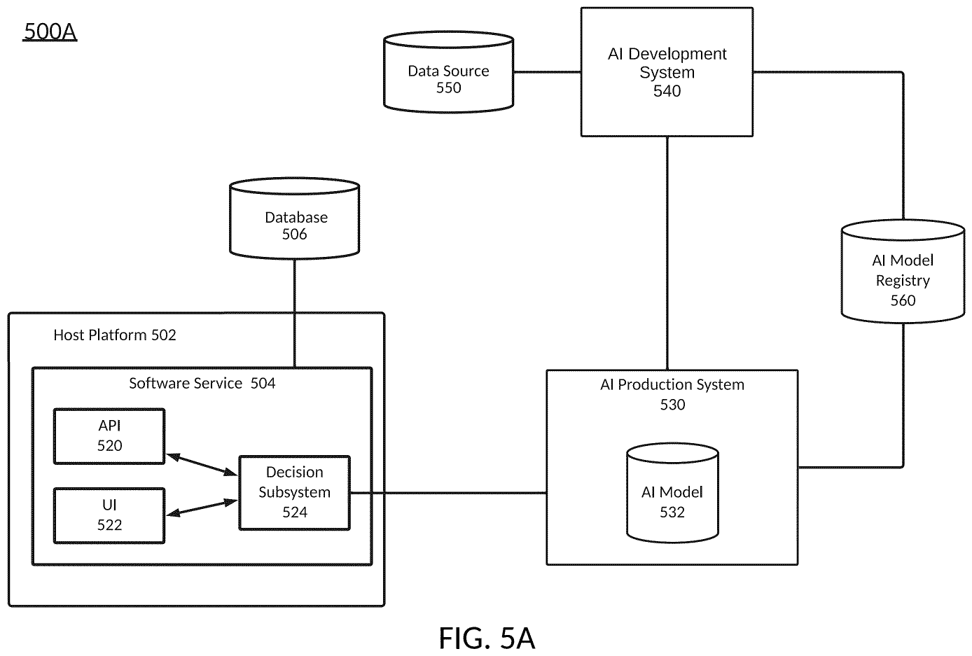

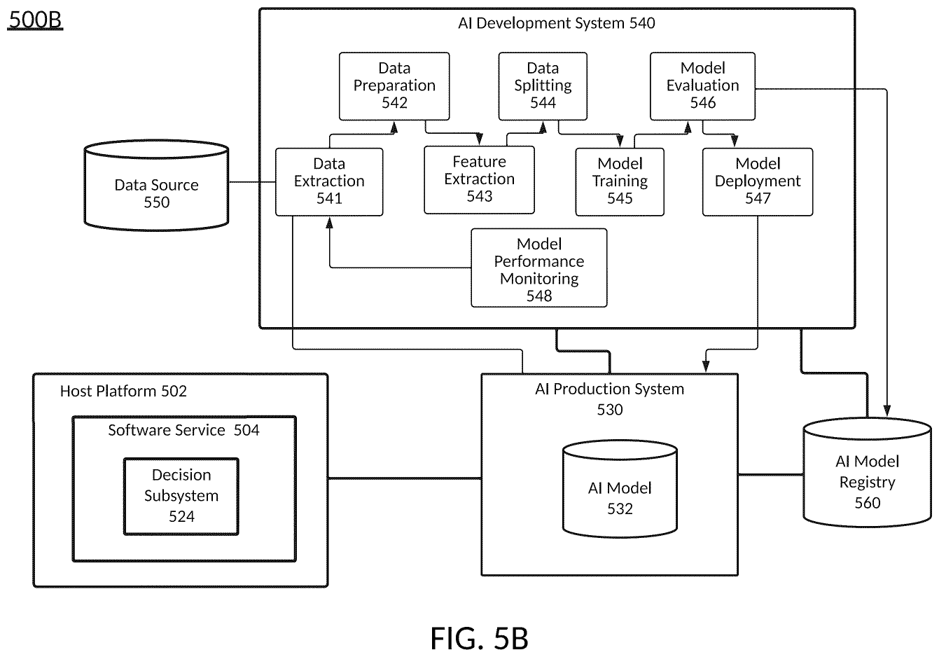

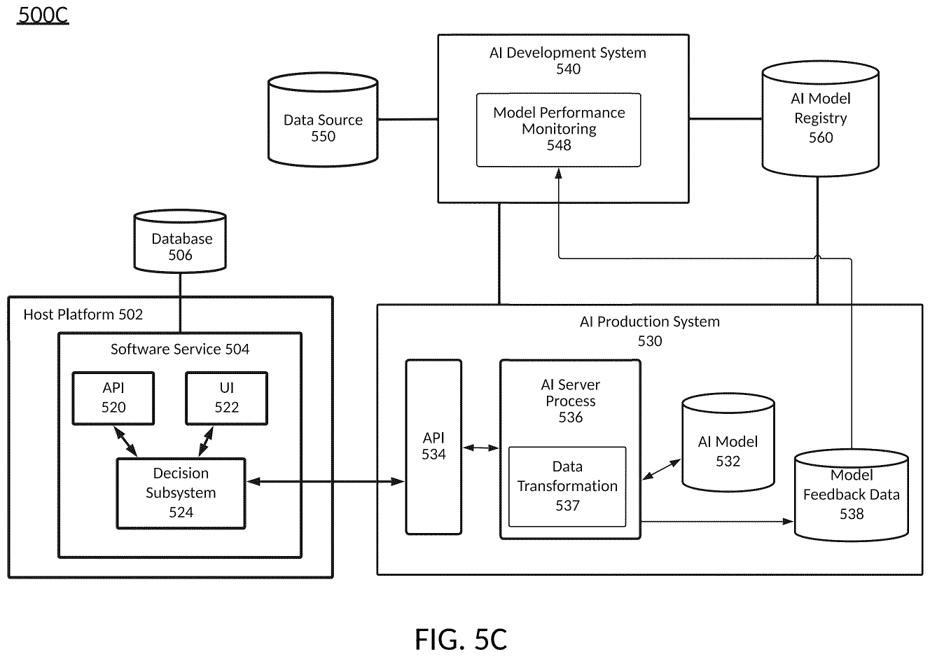

Detailed descriptions of training a machine learning model and executing a machine learning model are further described and depicted herein. The training and executing of the machine learning model described in the examples of FIGS. 5A-5C may be performed inside a confidential machine learning computing environment as described in the examples herein.

FIG. 5A illustrates an artificial intelligence (AI) network diagram 500A that supports AI-assisted decision points in a software service executing on a computer. As one example, the AI model being trained in the examples herein may refer to an AI model for any of the tasks performed herein including a machine learning model, a neural network, a large language model (LLM), and the like. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Artificial intelligence systems have been built and trained to perform various tasks in an automated manner. For example, artificial intelligence systems receive and understand verbal and/or written dialogue and function as digital assistants, speech-to-text programs, etc. Other artificial intelligence systems are trained on different types of information to allow the trained system to generate content-such as new works of art based on the styles seen, or new compound ideas based on the history of chemical research.

Foundation models are types of artificial intelligence systems that are trained on a broad set of unlabeled data that can be used for different tasks, with minimal fine-tuning. The unlabeled data includes in some instances imagery and/or language. In response to a short prompt being input into the foundation model, the system generates an output such as an entire essay, or a complex image, based on the parameters that are set forth in the input prompt. The foundation model is able to produce an output that attempts to meet the parameters even if the foundation model was never trained with specific training data that included the exact parameters, e.g., was never trained for that exact argument or to generate an image in that way.

Using self-supervised learning and transfer learning, foundation models can apply information that they have learnt about one situation to another. For example, like a human learns how to drive on one car, for example, and without too much effort, could learn how to drive other types of vehicles such as other cars, a truck, or a bus. The foundation model similarly is used to achieve proficiency in some new area without having to be trained completely from scratch. Foundation models seem to have inherent creativity in performing tasks such as stringing together coherent arguments or create entirely original pieces of art. Foundation models are established in the technology of natural-language processing. One example of how foundation models are helpful is that for previous generation of AI techniques, if you wanted to build an AI model that could summarize bodies of text for you, you would need tens of thousands of labeled examples just for the summarization use case. With a pre-trained foundation model, the labeled data requirements are dramatically reduced. First, the foundation model is fine-tuned with a domain-specific unlabeled corpus to create a domain-specific foundation model. Then, using a much smaller amount of labeled data, potentially just a thousand labeled examples, a foundation model is trained for summarization. The domain-specific foundation model can be used for many tasks as opposed to the previous technologies that required building models from scratch in each use case. Foundation models are even applicable in areas such as computer programming coding analysis, generation, and repair.

Some foundation models are used for sentiment analysis. With pre-trained foundation models, sentiment analysis on a new language can be trained using as little as a few thousand sentences—100 times fewer annotations required than previous models. Reducing labeling requirements will make it much easier for implementation in various technical areas. Systems that execute specific tasks in a single domain are giving way to broad AI that learns more generally and works across domains and problems. Foundation models, trained on large, unlabeled datasets and fine-tuned for an array of applications, are driving this shift.

Large language models (LLMs) are a category of foundation models trained on immense amounts of data making them capable of understanding and generating natural language and other types of content to perform a wide range of tasks. LLMs have been implemented at different levels to enhance their natural language understanding (NLU) and natural language processing (NLP) capabilities. This advancement of LLMs has occurred alongside advances in machine learning, machine learning models, algorithms, neural networks and the transformer models that provide the architecture for these AI systems.

LLMs are a class of foundation models, which are trained on enormous amounts of data to provide the foundational capabilities needed to drive multiple use cases and applications, as well as resolve a multitude of tasks. This LLM concept is in stark contrast to the idea of building and training domain specific models for each of these use cases individually, which is prohibitive under many criteria (most importantly cost and infrastructure), stifles synergies and can even lead to inferior performance.

LLMs represent a significant breakthrough in NLP and artificial intelligence. LLMs are accessible through interfaces like Open AI's Chat GPT-3 and GPT-4, which have garnered the support of Microsoft. Other examples include Meta's Llama models and Google's bidirectional encoder representations from transformers (BERT/RoBERTa) and PaLM models. IBM has also recently launched its Granite model series on watsonx.ai, which has become the generative AI backbone for other IBM products like watsonx Assistant and watsonx Orchestrate.

In a nutshell, LLMs are designed to understand and generate text like a human, in addition to other forms of content, based on the vast amount of data used to train them. They have the ability to infer from context, generate coherent and contextually relevant responses, translate to languages other than English, summarize text, answer questions (general conversation and FAQs) and even assist in creative writing or code generation tasks. LLMs are able to do some or all of these tasks thanks to many, e.g., billions of, parameters that enable them to capture intricate patterns in language and perform a wide array of language-related tasks. LLMs are revolutionizing applications in various fields, from chatbots and virtual assistants to content generation, research assistance and language translation.

LLMs operate by leveraging deep learning techniques and vast amounts of textual data. These models are typically based on a transformer architecture, like the generative pre-trained transformer, which excels at handling sequential data like text input. LLMs consist of multiple layers of neural networks, each with parameters that can be fine-tuned during training, which are enhanced further by a numerous layer known as the attention mechanism, which dials in on specific parts of data sets.

During the training process, these models learn to predict the next word in a sentence based on the context provided by the preceding words. The model does this through attributing a probability score to the recurrence of words that have been tokenized—broken down into smaller sequences of characters. These tokens are then transformed into embeddings, which are numeric representations of this context.

To ensure accuracy, this process involves training the LLM on a large corpus of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be harnessed for a wide range of NLU and content generation tasks.

Model performance can also be increased through prompt engineering, prompt-tuning, fine-tuning and other tactics like reinforcement learning with human feedback (RLHF) to remove the biases, hateful speech and factually incorrect answers known as “hallucinations” that are often unwanted byproducts of training on so much unstructured data. LLMs augment conversational AI in chatbots and virtual assistants to enhance the interactions that provide context-aware responses that mimic interactions with human agents.

LLMs also excel in content generation, automating content creation for blog articles, explanatory materials, and other writing tasks. LLMs aid in summarizing and extracting information from vast datasets, accelerating knowledge discovery. LLMs also play a vital role in language translation, breaking down language barriers by providing accurate and contextually relevant translations. LLMs can even be used to write code, or “translate” between programming languages. LLMs contribute to accessibility by assisting individuals with disabilities, including text-to-speech applications and generating content in accessible formats.

LLMs often include abilities such as:
Text generation: language generation abilities, such as writing emails, blog posts or other mid-to-long form content in response to prompts that can be refined and polished. An excellent example is retrieval-augmented generation (RAG).
Content summarization: summarize long articles, news stories, research reports, corporate documentation and even interaction history into thorough texts tailored in length to the output format.
AI assistants: chatbots that answer queries, perform backend tasks and provide detailed information in natural language as a part of an integrated, self-serve solution for handling inquiries.
Code generation: assists developers in building applications, finding errors in code and uncovering security issues in multiple programming languages, even “translating” between them.
Sentiment analysis: analyze text to determine a user's tone in order to understand user feedback at scale and aid in brand reputation management.
Language translation: provides wider coverage to organizations across languages and geographies with fluent translations and multilingual capabilities.

Software service 504 (see FIG. 5A), executing on host platform 502 (see FIG. 5A) may provide one or more application programming interfaces (APIs) 520 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 520 send data to one or more decision subsystems 524 of the software service 504 to assist in decision-making. In some examples and features of the instant solution, the software service 504 stores data included in API requests or data generated during processing the API requests into one or more databases 506 (see FIG. 5A).

Software service 504 may provide one or more user interfaces (UIs) 522, such as a server-side hosted graphical user interface (GUI). In some examples and features of the instant solution, the UIs 522 provided employ template-based frameworks, component-based frameworks, etc. In some examples and features of the instant solution, these UIs 522 send data to one or more decision subsystems 524 of the software service 504 to assist with decision-making. In some examples and features of the instant solution, the software service 504 stores data included in UI requests or data generated during processing the UI requests into one or more databases 506.

Software service 504 may include one or more decision subsystems 524 that drive a decision-making process of the software service 504. In some examples and features of the instant solution, the decision subsystems 524 receive data from one or more APIs 520 as input into the decision-making process. In some examples and features of the instant solution, a decision subsystem 524 may receive data from one or more UIs 522 as input to the decision-making process. A decision subsystem 524 may gather service configuration or historical execution data from one or more databases 506 to aid in the decision-making process. A decision subsystem 524 may provide feedback to an API 520 or a UI 522.

An AI production system 530 may be used by a decision subsystem 524 in a software service 504 to assist in its decision-making process. The AI production system 530 includes one or more AI models 532 that are executed to generate a response, such as, but not limited to, a prediction, a categorization, a UI prompt, etc. In some examples and features of the instant solution, an AI production system 530 is hosted on a server. In some examples and features of the instant solution, the AI production system 530 is cloud-hosted. In some examples and features of the instant solution, the AI production system 530 is deployed in a distributed multi-node architecture.

An AI development system 540 creates one or more AI models 532. In some examples and features of the instant solution, the AI development system 540 utilizes data from one or more data sources 550 to develop and train one or more AI models 532. The data sources 550 may be local or third-party data sources. Further, the data provided by the data sources may be real-world or synthetic. In some examples and features of the instant solution, the AI development system 540 utilizes feedback data from one or more AI production systems 530 for new model development and/or existing model re-training. In some examples and features of the instant solution, the AI development system 540 resides and executes on a server. In some examples and features of the instant solution, the AI development system 540 is cloud hosted. In some examples and features of the instant solution, the AI development system 540 is deployed in a distributed multi-node architecture. In some examples and features of the instant solution, the AI development system 540 utilizes a distributed data pipeline/analytics engine.

Once an AI model 532 has been trained and validated in the AI development system 540, it may be stored in an AI model registry 560 for retrieval by either the AI development system 540 or by one or more AI production systems 530. The AI model registry 560 resides in a dedicated server in one example of the instant solution. In some examples and features of the instant solution, the AI model registry 560 is cloud-hosted. In some examples and features of the instant solution, the AI model registry 560 resides in the AI production system 530. In some examples and features of the instant solution, the AI model registry 560 is a distributed database.

FIG. 5B illustrates a process 500B for developing one or more AI models that support AI-assisted decision points. An AI development system 540 executes steps to develop an AI model 532 that begins with data extraction 541, in which data is loaded and ingested from one or more data sources 550. In some examples and features of the instant solution, historical model feedback data is extracted from one or more AI production systems 530.

Once the data has been extracted during data extraction 541, it undergoes data preparation 542 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 542 may be a manual process or an automated process using one or more of the elements and/or functions described and/or depicted herein.

Features of the data are identified and extracted during the feature extraction step 543. In some examples and features of the instant solution, a feature of the data is internal to the prepared data from the data preparation step 542. In some examples and features of the instant solution, a feature of the data requires a piece of prepared data from the data preparation step 542 to be enriched by data from another data source to be useful in developing the AI model 532. In some examples and features of the instant solution, identifying relevant features (relevant attributes) for model training are performed via an automated process using one or more of the elements and/or functions described and/or depicted herein. Once the features have been identified, the values of the features are collected into a dataset that will be used to develop the AI model 532.

The dataset output from the feature extraction step 543 is split 544 into a training and validation data set. The training data set is used to train the AI model 532, and the validation data set is used to evaluate the performance of the AI model 532 on unseen data.

The AI model 532 is trained and tuned 545 using the training data set from the data splitting step 544. In this step, the training data set is provided to an AI algorithm and an initial set of algorithm parameters which may be automatically determined based on the interdependence between the relevant attributes determined according to various embodiments. The performance of the AI model 532 is then tested within the AI development system 540 utilizing the validation data set from step 544. These steps may be repeated with adjustments to one or more algorithm parameters until the model's performance is acceptable based on various goals and/or results.

The AI model 532 is evaluated 546 in a staging environment (not shown) that resembles the target AI production system 530. This evaluation uses a validation dataset to ensure the performance in an AI production system 530 matches or exceeds expectations. In some examples and features of the instant solution, the validation dataset from step 544 is used. In some examples and features of the instant solution, one or more unseen validation datasets are used. In some examples and features of the instant solution, the staging environment is part of the AI development system 540, and the staging environment is managed separately from the AI development system 540. Once the AI model 532 has been validated, it is stored in an AI model registry 560, where it can be retrieved for deployment and future updates. In some examples and features of the instant solution, the model evaluation step 546 may be a manual process or an automated process using one or more of the elements and/or functions described and/or depicted herein.

In some examples and features of the instant solution, the AI development system includes a user interface (not shown). The user interface may be used to manage the development system infrastructure, the steps 541-548 within the development system, the interim data transmitted between the various steps 541-548, and the data sources 550.

Once an AI model 532 has been validated and published to an AI model registry 560, it may be deployed during the model deployment step 547 to one or more AI production systems 530. In some examples and features of the instant solution, the performance of deployed AI model 532 is monitored 548 by the AI development system 540. In some examples and features of the instant solution, AI model 532 feedback data is provided by the AI production system 530 to enable model performance monitoring 548, and the AI development system 540 periodically requests feedback data for model performance monitoring 548, which includes one or more triggers that result in the AI model 532 being updated by repeating steps 541-548 with updated data from one or more data sources 550.

FIG. 5C illustrates a process 500C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 5C, an AI production system 530 may be used by a decision subsystem 524 in software service 504 to assist in its decision-making process. The AI production system 530 provides an API 534, executed by an AI server process 536 through which requests can be made. In some examples and features of the instant solution, a request may include an AI model 532 identifier to be executed based on the type of request. In some examples and features of the instant solution, a data payload (e.g., to be input to the AI model during execution) is included in the request. The data payload may include API 520 data from software service 504, UI 522 data from software service 504 or data from other software service 504 subsystems (not shown).

Upon receiving the API 534 request, the AI server process 536 may transform 537 the data payload or portions of the data payload to be valid feature values in an AI model 532. Data transformation 537 may include, but is not limited to, combining data values, normalizing data values, and enriching the incoming data with data from other data sources 550. Once the data transformation occurs, the AI server process 536 executes the appropriate AI model 532 using the transformed input data. Upon receiving the execution result, the AI server process 536 responds to the API requester, which is a decision subsystem 524 of software service 504. In some examples and features of the instant solution, the response may result in an update to a UI 522 in software service 504. In some examples and features of the instant solution, the response includes a request identifier that can be used later by the software service 504 to provide feedback on the performance of the AI model 532. In some examples and features of the instant solution, a model feedback record may be added into a model feedback data 538 by the AI server process 536.

In some examples and features of the instant solution, the API 534 includes an interface to provide AI model 532 feedback after an AI model 532 execution response has been processed. This mechanism enables the requester to provide feedback on the accuracy of the AI model 532 results. In some examples and features of the instant solution, the feedback interface includes the identifier of the initial request so that it can be used to associate the feedback with the request. Upon receiving a call into the feedback interface of the API 534, the AI server process 536 creates and adds a model feedback record into the model feedback data 538 which holds historical model feedback records. In some examples and features of the instant solution, the records in this model feedback data 538 are provided to model performance monitoring 548 in the AI development system 540. This model feedback data is streamed to the AI development system 540 or may be provided upon request. In some examples and features of the instant solution, the model feedback records in the model feedback data 538 are used as an input for retraining the AI model 532.

In some examples and features of the instant solution, the AI production system 530 includes a user interface (not shown). The user interface may be used to manage the production system infrastructure, the components of the production system 530-538, and the operation of the AI production system and its components.

The above embodiments may be implemented in hardware, in a computer program executed by a processor, in firmware, or in a combination of the above. A computer program may be embodied on a computer-readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A method comprising:
executing a machine learning (ML) model on an input text to generate an output text that comprises a summary of the input text, wherein the input text comprises a first group of sentences and the output text comprises a second group of sentences;
generating different possible combinations of sentences from the first group of sentences and embedding the different possible combinations of sentences to generate a plurality of embeddings in vector space;
embedding a sentence from the output text in the vector space to generate a target embedding;
identifying a hallucination within the output text based on a distance between the target embedding and the plurality of embeddings in the vector space; and
generating a feedback record that includes the input text, the output text, and the hallucination within the output text.

2. The method of claim 1, further comprising training the ML model to generate the summary based on historical input texts mapped to historical summaries corresponding thereto, and retraining the ML model to refine the summary based on the feedback record.

3. The method of claim 1, further comprising storing the plurality of embeddings in an indexed data structure, executing a cross-encoder model on the target embedding of the sentence with respect to the plurality of embeddings of the first group of sentences to identify a top N embeddings that are most similar to the target embedding, respectively, and storing similarities of the top N embeddings in a similarity matrix.

4. The method of claim 3, wherein the identifying the hallucination comprises determining that the sentence contains hallucinated content with respect to the input text based on respective similarities between the target embedding and the plurality of embeddings stored within the indexed data structure.

5. The method of claim 1, further comprising executing a cross encoder model on the target embedding with respect to each embedding in the plurality of embeddings to generate a plurality of similarity values, respectively, and determining that the sentence is missing from the summary based on each of the plurality of similarity values each being less than a predetermined threshold value.

6. The method of claim 1, wherein the identifying comprises identifying the sentence as the hallucination based on respective similarities between the target embedding and the plurality of embeddings in the vector space being less than a predetermined threshold, and generating the feedback record to include the sentence identified as the hallucination.

7. The method of claim 1, wherein the input text comprises unstructured text, and the method further comprises executing a second ML model on the unstructured text to generate the first group of sentences from the unstructured text, wherein the executing the ML model comprises executing the ML model on the first group of sentences generated by the second ML model.

8. A computer system comprising:
a processor set;
a set of one or more computer-readable storage media; and
program instructions, collectively stored in the set of one or more storage media, that cause the processor set to perform computer operations comprising:
executing a machine learning (ML) model on an input text to generate an output text that comprises a summary of the input text, wherein the input text comprises a first group of sentences and the output text comprises a second group of sentences;
generating different possible combinations of sentences from the first group of sentences and embedding the different possible combinations of sentences to generate a plurality of embeddings in vector space;
embedding a sentence from the output text in the vector space to generate a target embedding;
identifying a hallucination within the output text based on a distance between the target embedding and the plurality of embeddings in the vector space; and
generating a feedback record that includes the input text, the output text, and the hallucination within the output text.

9. The computer system of claim 8, wherein the computer operations further comprise training the ML model to generate the summary based on historical input texts mapped to historical summaries corresponding thereto, and retraining the ML model to refine the summary based on the feedback record.

10. The computer system of claim 8, wherein the computer operations further comprise storing the plurality of embeddings in an indexed data structure, executing a cross-encoder model on the target embedding of the sentence with respect to the plurality of embeddings of the first group of sentences to identify a top N embeddings that are most similar to the target embedding, respectively, and storing similarities of the top N embeddings in a similarity matrix.

11. The computer system of claim 10, wherein the identifying the hallucination comprises determining that the sentence contains hallucinated content with respect to the input text based on respective similarities between the target embedding and the plurality of embeddings stored within the indexed data structure.

12. The computer system of claim 8, wherein the computer operations further comprise executing a cross encoder model on the target embedding with respect to each embedding in the plurality of embeddings to generate a plurality of similarity values, respectively, and determining that the sentence is missing from the summary based on each of the plurality of similarity values each being less than a predetermined threshold value.

13. The computer system of claim 8, wherein the identifying comprises identifying the sentence as the hallucination based on respective similarities between the target embedding and the plurality of embeddings in the vector space being less than a predetermined threshold, and generating the feedback record to include the sentence identified as the hallucination.

14. The computer system of claim 8, wherein the input text comprises unstructured text, and the computer operations further comprise executing a second ML model on the unstructured text to generate the first group of sentences from the unstructured text, wherein the executing the ML model comprises executing the ML model on the first group of sentences generated by the second ML model.

15. A computer program product comprising:
a set of one or more computer-readable storage media; and
program instructions, collectively stored in the set of one or more computer-readable storage media, for causing a processor set to perform computer operations comprising:
executing a machine learning (ML) model on an input text to generate an output text that comprises a summary of the input text, wherein the input text comprises a first group of sentences and the output text comprises a second group of sentences;
generating different possible combinations of sentences from the first group of sentences and embedding the different possible combinations of sentences to generate a plurality of embeddings in vector space;
embedding a sentence from the output text in the vector space to generate a target embedding;
identifying a hallucination within the output text based on a distance between the target embedding and the plurality of embeddings in the vector space; and
generating a feedback record that includes the input text, the output text, and the hallucination within the output text.

16. The computer program product of claim 15, wherein the computer operations further comprise training the ML model to generate the summary based on historical input texts mapped to historical summaries corresponding thereto, and retraining the ML model to refine the summary based on the feedback record.

17. The computer program product of claim 15, wherein the computer operations further comprise storing the plurality of embeddings in an indexed data structure, executing a cross-encoder model on the target embedding of the sentence with respect to the plurality of embeddings of the first group of sentences to identify a top N embeddings that are most similar to the target embedding, respectively, and storing similarities of the top N embeddings in a similarity matrix.

18. The computer program product of claim 17, wherein the identifying the hallucination comprises determining that the sentence contains hallucinated content with respect to the input text based on respective similarities between the target embedding and the plurality of embeddings stored within the indexed data structure.

19. The computer program product of claim 15, wherein the computer operations further comprise executing a cross encoder model on the target embedding with respect to each embedding in the plurality of embeddings to generate a plurality of similarity values, respectively, and determining that the sentence is missing from the summary based on each of the plurality of similarity values each being less than a predetermined threshold value.

20. The computer program product of claim 15, wherein the identifying comprises identifying the sentence as the hallucination based on respective similarities between the target embedding and the plurality of embeddings in the vector space being less than a predetermined threshold, and generating the feedback record to include the sentence identified as the hallucination.
